(19) United States
(12) Patent Application Publication
(10) Pub. No.: US 2026/0086389 A1
(43) Pub. Date: Mar. 26, 2026

(54) SMART GLASSES

(71) Applicant: AAC ACOUSTIC TECHNOLOGIES (SHENZHEN) CO., LTD., Shenzhen (CN)

(72) Inventors: Xiuliang Xie, Shenzhen (CN); Qingshan Xu, Shenzhen (CN); Hongyan Tao, Shenzhen (CN)

(21) Appl. No.: 18/983,086

(22) Filed: Dec. 16, 2024

Related U.S. Application Data
(63) Continuation of application No. PCT/CN2024/121159, filed on Sep. 25, 2024.

(51) Int. Cl. G02C 5/16; G02C 5/22

(52) U.S. Cl. CPC G02C 5/16; G02C 5/2209; G02C 2200/08

(57) ABSTRACT

Smart glasses are provided, including a frame assembly, two female connecting assemblies, and two temple assemblies. The two female connecting assemblies are respectively fixed to two opposite ends of the frame assembly, and the two temple assemblies are respectively connected to the two female connecting assemblies. Each of the two female connecting assemblies includes a female connector, a clamping groove, a bracket, an inserting groove, and an elastic metal component. Each of the two temple assemblies includes a temple and a male connector, each male connector is fixed to one end of a corresponding temple close to a corresponding one of the two female connecting assemblies. The smart glasses enable quick replacement of the two temple assemblies or the frame assembly.

### TECHNICAL FIELD

The present disclosure relates to the field of glasses, and in particular to smart glasses.

### BACKGROUND

Glasses are one kind of optical devices for improving vision, protecting eyes, or serving as accessories, and lenses of which are selected according to different applications. If the glasses are used for improving the vision, lenses having a vision adjusting function are selected; if the glasses are used for protecting the eyes, lenses having a corresponding protective function are selected, such as sunglasses lenses or protective lenses; and if the glasses are used as the accessories, plano lenses are correspondingly selected.

The glasses in the related art include a lens frame and temples, the lens frame is configured to mount lenses, and the temples are configured to hold the glasses in place. In order to better store the glasses, the temples of the glasses are hinged to the lens frame, which is convenient for folding and storage of the temples.

However, in the related art, a hinge structure and the temples of the glasses are fixed either using adhesive or screws. If the hinge structure and the temples are fixed using the adhesive, the lens frame or the temples cannot be replaced. Although the hinge structure and the temples can be detached from each other when being fixed using the screws, replacing the lens frame or the temples is time-consuming.

Therefore, it is necessary to provide a pair of smart glasses to solve above problems.

### SUMMARY

A technical problem to be solved by the present disclosure is how to provide a pair of smart glasses to solve a problem in the related art that replacing a lens frame or temples of glasses is time-consuming.

In order to solve the technical problem, the present disclosure provides smart glasses, including a frame assembly, two female connecting assemblies, and two temple assemblies. The two female connecting assemblies are respectively fixed to two opposite ends of the frame assembly, and the two temple assemblies are respectively connected to the two female connecting assemblies. Each of the two female connecting assemblies includes a female connector, a clamping groove, a bracket, an inserting groove, and an elastic metal component. Each female connector is hinged to the frame assembly, each clamping groove is recessed inward from one end of a corresponding female connector close to a corresponding one of the two temple assemblies, each bracket is clamped and fixed in a corresponding clamping groove, each inserting groove is recessed inward from one end of a corresponding bracket close to a corresponding one of the two temple assemblies, each elastic metal component is clamped between a corresponding female connector and a corresponding bracket, and two ends of each elastic metal component extend into a corresponding inserting groove. Each of the two temple assemblies includes a temple and a male connector, each male connector is fixed to one end of a corresponding temple close to a corresponding one of the two female connecting assemblies, each male connector defines at least one limiting groove at a peripheral side thereof, each male connector is inserted into a corresponding inserting groove, and the two ends of each elastic metal component are elastically clamped in corresponding at least one limiting groove.

As an improvement, each elastic metal component includes a first segment and two second segments, each two second segments are formed by respectively bending two ends of a corresponding first segment. Each bracket defines a mounting groove recessed inward from a surface of a first peripheral side surface thereof, each bracket further defines two mounting holes being strip-shaped and respectively penetrating through a second peripheral side thereof and a third peripheral side thereof, each second peripheral side is opposite to a corresponding third peripheral side, each two mounting holes are communicated with a corresponding inserting groove, and each two mounting holes are respectively defined at two opposite sides of a corresponding mounting groove and are communicated with the corresponding mounting groove. Each first segment is fixed in a corresponding mounting groove, each two second segments respectively pass through corresponding two mounting holes and extend into a corresponding inserting groove. Each two second segments are elastically clamped in corresponding at least one limiting groove, so that a corresponding male connector is locked with a corresponding bracket.

As an improvement, a width of one end of each male connector away from the corresponding temple is less than or equal to a distance between corresponding two segments. Each at least one limiting groove includes two limiting grooves, each two limiting grooves are respectively defined at two sides of a corresponding male connector corresponding to corresponding two second segments, where a distance between the two sides of the corresponding male connector is greater than the distance between the corresponding two second segments.

As an improvement, cross sections of each two segments are circular, and cross sections of each two limiting grooves are arc-shaped.

As an improvement, one end of each bracket close to the frame assembly is fixed in the corresponding clamping groove through adhesive bonding.

As an improvement, each female connector defines a buckling groove on one side thereof away from a corresponding first segment. Each bracket defines a through hole at a fourth peripheral side thereof close to a corresponding buckling groove and penetrating through the fourth peripheral side thereof. Each bracket further includes a buckling portion at an area thereof corresponding to a corresponding through hole, each buckling portion is matched with a corresponding buckling groove. Each buckling portion is buckled with the corresponding buckling groove to fix and clamp a corresponding bracket.

As an improvement, each temple defines a concave groove at the one end thereof close to a corresponding one of the two female connecting assemblies, each male connector is fixed in a corresponding concave groove through in-mold injection molding or adhesive bonding.

As an improvement, each female connector is a metal female connector, each bracket is a plastic bracket, and each male connector is a metal male connector.

As an improvement, each elastic metal component is a steel wire.

As an improvement, the two female connecting assemblies include two connecting components being arc-shaped and fixed to the frame assembly. A hinge base is disposed on a peripheral side surface of each female connector, each hinge base is fixed to one end, away from the frame assembly, of a corresponding one of the two connecting components through a bolt.

Compared with the related art, in the smart glasses of the present disclosure, the two temple assemblies are respectively connected to the frame assembly through the two female connecting assemblies, the two ends of each elastic metal component in the two female connecting assemblies respectively extend into the corresponding inserting groove, each male connector defines the at least one limiting groove at the peripheral side thereof, each male connector in the two temple assembles in is inserted into the corresponding inserting groove, and the two ends of each elastic metal component are elastically clamped in the corresponding at least one limiting groove. In this way, when replacing the two temple assemblies or the frame assembly, each temple is directly pulled out of the inserting groove of a corresponding one of the two female connecting assemblies by applying force, which allows for quick replacement of the two temple assemblies or the frame assembly, thereby saving time and enhancing efficiency of a replacement process.

### BRIEF DESCRIPTION OF DRAWINGS

In order to more clearly illustrate technical solutions in embodiments of the present disclosure, drawings required in description of the embodiments are briefly described below, and obviously, the accompanying drawings in following description are merely some embodiments of the present disclosure, and for those who skilled in the art, other drawings may be obtained according to the accompanying drawings without creative efforts, in the drawings:

FIG. 1 is a three-dimensional structural schematic diagram of smart glasses according to one embodiment of the present disclosure.

FIG. 2 is an exploded structural schematic diagram of the smart glasses according to one embodiment of the present disclosure.

FIG. 3 is a cross-sectional schematic diagram taken along the line A-A of FIG. 1 with a partial enlarged cross-sectional structural schematic diagram.

FIG. 4 is a structural schematic diagram of a female connector, a bracket, and an elastic metal component according to one embodiment of the present disclosure.

FIG. 5 is a structural schematic diagram of the bracket, the elastic metal component, and a male connector according to one embodiment of the present disclosure.

Reference numerals in the drawings: 100. smart glasses; 1. frame assembly; 2. female connecting assembly; 21. female connector; 211. buckling groove; 212. hinge base; 213. bolt; 22. clamping groove; 23. bracket; 231. mounting groove; 232. mounting hole; 233. through hole; 234. buckling portion; 24. inserting groove; 25. elastic metal component; 251. first segment; 252. second segment; 26. connecting component; 3. temple assembly; 31. temple; 311. concave groove; 32. male connector; 321. limiting groove.

### DETAILED DESCRIPTION OF EMBODIMENTS

Technical solutions in embodiments of the present disclosure are clearly and completely described below with reference to accompanying drawings of the embodiments of the present disclosure. Obviously, the described embodiments are only a part but not all of the embodiments of the present disclosure. All other embodiments obtained by those who skilled in the art based on the embodiments of the present disclosure without creative efforts shall fall within a protection scope of the present disclosure.

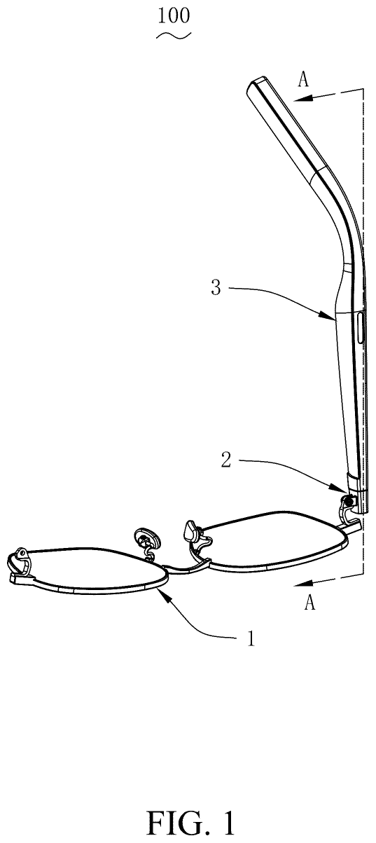

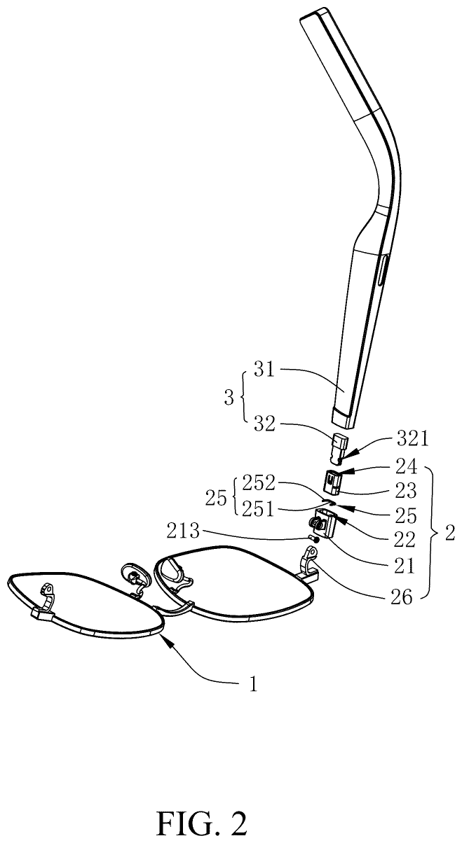

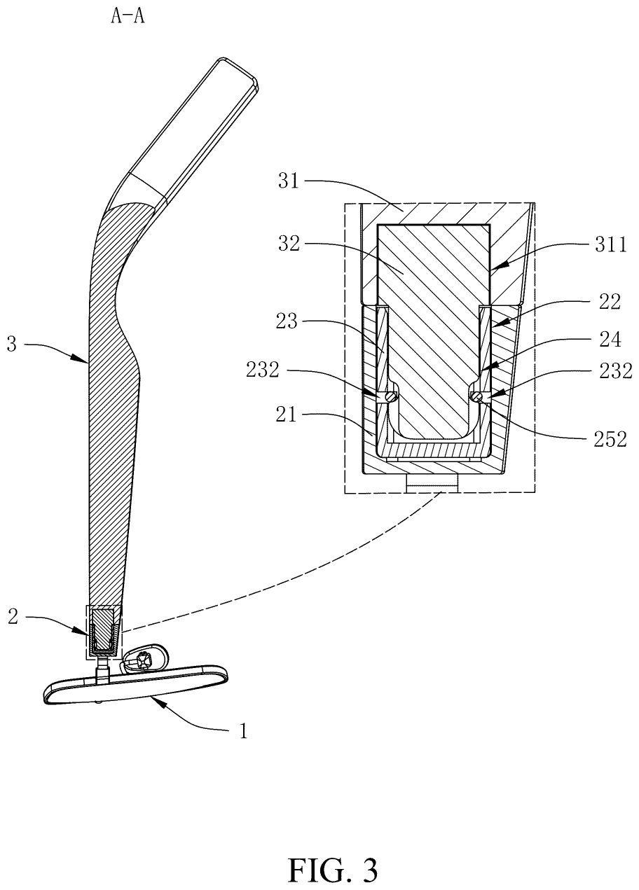

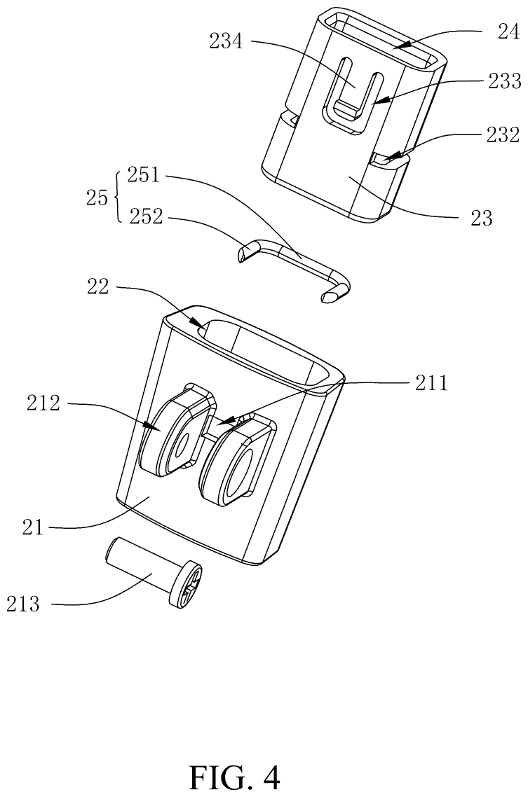

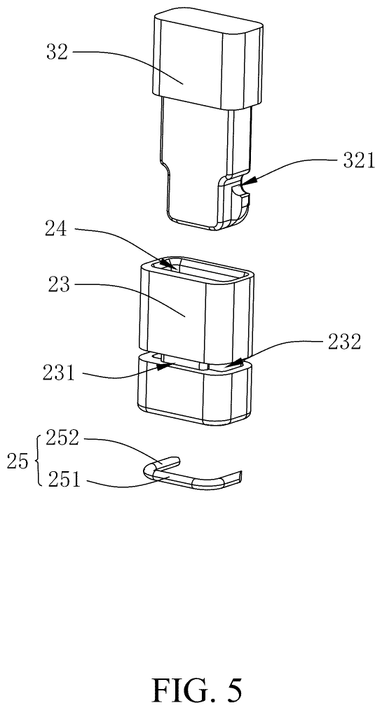

The embodiments of the present disclosure provide smart glasses 100, as shown in FIGS. 1-5, including a frame assembly 1, two female connecting assemblies 2, and two temple assemblies 3. The two female connecting assemblies 2 are respectively fixed to two opposite ends of the frame assembly 1, and the two temple assemblies 3 are respectively connected to the two female connecting assemblies 2.

Each of the two female connecting assemblies 2 includes a female connector 21, a clamping groove 22, a bracket 23, an inserting groove 24, and an elastic metal component 25. Each female connector 21 is hinged to the frame assembly 1, each clamping groove 22 is recessed inward from one end of a corresponding female connector 21 close to a corresponding one of the two temple assemblies 3, each bracket 23 is clamped and fixed in a corresponding clamping groove 22, each inserting groove 24 is recessed inward from one end of a corresponding bracket 23 close to a corresponding one of the two temple assemblies 3, each elastic metal component 25 is clamped between a corresponding female connector 21 and a corresponding bracket 23, and two ends of each elastic metal component 25 extend into a corresponding inserting groove 24.

In the embodiments, each elastic metal component 25 is a steel wire. In this way, structural strength of each elastic metal component 25 is enhanced.

Each of the two temple assemblies 3 includes a temple 31 and a male connector 32, each male connector 32 is fixed to one end of a corresponding temple 31 close to a corresponding one of the two female connecting assemblies 2, each male connector 32 defines at least one limiting groove 321 at a peripheral side thereof, each male connector 32 is inserted into a corresponding inserting groove 24, and the two ends of each elastic metal component 25 are elastically clamped in corresponding at least one limiting groove 321.

Specifically, each elastic metal component 25 includes a first segment 251 and two second segments 252, each two second segments 252 are formed by respectively bending two ends of a corresponding first segment 251, that is, each elastic metal component 25 is U-shaped. Each bracket 23 defines a mounting groove 231 recessed inward from a surface of a first peripheral side surface thereof, each bracket 23 further defines two mounting holes 232 being strip-shaped and respectively penetrating through a second peripheral side thereof and a third peripheral side thereof, each second peripheral side is opposite to a corresponding third peripheral side, each two mounting holes 232 are communicated with a corresponding inserting groove 24, and each two mounting holes 232 are respectively defined at two opposite sides of a corresponding mounting groove 231 and are communicated with the corresponding mounting groove 231. Each first segment 251 is fixed in a corresponding mounting groove 231, each two second segments 232 respectively pass through corresponding two mounting holes 232 and extend into a corresponding inserting groove 24. Each two second segments 232 are elastically clamped in corresponding at least one limiting groove 231, so that a corresponding male connector 32 is locked with a corresponding bracket 23.

A recessing direction of each mounting groove 231 is from the first peripheral side surface of a corresponding bracket 23 to an interior of the corresponding 23.

A width of one end of each male connector 32 away from the corresponding temple 31 is less than or equal to a distance between corresponding two segments 252. Each at least one limiting groove 321 includes two limiting grooves 321, each two limiting grooves 321 are respectively defined at two sides of a corresponding male connector 32 corresponding to corresponding two second segments 252, where a distance between the two sides of the corresponding male connector 32 is greater than the distance between the corresponding two second segments 252, each two limiting grooves 321 are respectively elastically buckled with the corresponding two second segments 252 to clamp and fix the corresponding male connector 32.

When each male connector 32 is inserted into the corresponding inserting groove 24, the two second segments 252 of the corresponding elastic metal component 25 are pressed to respectively deform in a direction away from each other, after each male connector 32 is completely inserted into the corresponding inserting groove 24, the two limiting grooves 321 at the two sides of the corresponding male connector 32 are aligned with the two second segments 252 of the corresponding elastic metal component 25, and the two second segments 252 of the corresponding elastic metal component 25 are driven by an elastic force to restore to an initial state, that is, the two second segments 252 of the corresponding elastic metal component 25 are respectively inserted into the two limiting grooves 321 at the two sides of the corresponding male connector 32, in this way, each male connector 32 is locked in the inserting groove 24 of the corresponding bracket 23 through the corresponding elastic metal component 25.

When the frame assembly 1 or the two temple assemblies 3 need to be replaced, the corresponding male connector 32 is quickly pulled out by external force. Specifically, the two second segments 252 of the corresponding elastic metal component 25 are pressed to respectively deform in the direction away from each other to quickly pull the corresponding male connector 32 out of the corresponding inserting groove 24. Then, a new component is provided and correspondingly mounted to complete quick replacement of the frame assembly 1 or the two temple assemblies 3.

Cross sections of each two segments 252 are circular, and cross sections of each two limiting grooves 321 are arc-shaped. In this way, each two segments 252 are driven by the elastic force to smoothly clamped into the corresponding limiting grooves 321.

Each female connector 21 defines a buckling groove 211 on one side thereof away from a corresponding first segment 251. Each bracket 23 defines a through hole 233 at a fourth peripheral side thereof close to a corresponding buckling groove 211 and penetrating through the fourth peripheral side thereof. Each bracket 23 further includes a buckling portion 234 at an area thereof corresponding to a corresponding through hole 233, each buckling portion 234 is matched with a corresponding buckling groove 211. Each buckling portion 234 is buckled with the corresponding buckling groove 211 to fix and clamp a corresponding bracket 23. In this way, connection stability between each bracket 23 and a corresponding one of the two female connecting assemblies 2 is improved, thereby avoiding separation or detachment during use.

One end of each bracket 23 close to the frame assembly 1 is fixed in the corresponding clamping groove 22 through adhesive bonding. In this way, connection stability between each bracket 23 and a corresponding one of the two female connecting assemblies 2 is further improved.

Each temple 31 defines a concave groove 311 at the one end thereof close to a corresponding one of the two female connecting assemblies 2, each male connector 32 is fixed in a corresponding concave groove 311 through in-mold injection molding or adhesive bonding. In this way, connection stability between each temple 31 and a corresponding male connector 32 is improved.

Each female connector 21 is a metal female connector, each bracket 23 is a plastic bracket, and each male connector 32 is a metal male connector. In this way, an overall weight of the smart glasses is reduced.

The two female connecting assemblies 2 include two connecting components 26 being arc-shaped and fixed to the frame assembly 1. A hinge base 212 is disposed on a peripheral side surface of each female connector 21, each hinge base 212 is fixed to one end, away from the frame assembly 1, of a corresponding one of the two connecting components 26 through a bolt 213. In this way, each female connector 21 is easily hinged to a corresponding frame assembly 1.

Compared with the related art, in the smart glasses 100 of the present disclosure, the two temple assemblies 3 are respectively connected to the frame assembly 1 through the two female connecting assemblies 2, the two ends of each elastic metal component 25 in the two female connecting assemblies 2 respectively extend into the corresponding inserting groove 24, each male connector 32 defines the at least one limiting groove 321 at the peripheral side thereof, each male connector 32 in the two temple assembles 3 in is inserted into the corresponding inserting groove 24, and the two ends of each elastic metal component 25 are elastically clamped in the corresponding at least one limiting groove 321. In this way, when replacing the two temple assemblies 3 or the frame assembly 1, each temple 31 is directly pulled out of the inserting groove 24 of a corresponding one of the two female connecting assemblies 2 by applying force, which allows for quick replacement of the two temple assemblies 3 or the frame assembly 1, thereby saving time and enhancing efficiency of a replacement process.

The foregoing are merely embodiments of the present disclosure, and it should be noted that, for those who skilled in the art, improvements can be made without departing from the concepts of the present disclosure, but these are all within the protection scopes of the present disclosure.

What is claimed is:

1. Smart glasses, comprising:
a frame assembly;
two female connecting assemblies; and
two temple assemblies;
wherein the two female connecting assemblies are respectively fixed to two opposite ends of the frame assembly, and the two temple assemblies are respectively connected to the two female connecting assemblies;
each of the two female connecting assemblies comprises a female connector, a clamping groove, a bracket, an inserting groove, and an elastic metal component;
each female connector is hinged to the frame assembly, each clamping groove is recessed inward from one end of a corresponding female connector close to a corresponding one of the two temple assemblies, each bracket is clamped and fixed in a corresponding clamping groove, each inserting groove is recessed inward from one end of a corresponding bracket close to a corresponding one of the two temple assemblies, each elastic metal component is clamped between a corresponding female connector and a corresponding bracket, and two ends of each elastic metal component extend into a corresponding inserting groove; and
each of the two temple assemblies comprises a temple and a male connector, each male connector is fixed to one end of a corresponding temple close to a corresponding one of the two female connecting assemblies, each male connector defines at least one limiting groove at a peripheral side thereof, each male connector is inserted into a corresponding inserting groove, and the two ends of each elastic metal component are elastically clamped in corresponding at least one limiting groove.

2. The smart glasses according to claim 1, wherein each elastic metal component comprises a first segment and two second segments, each two second segments are formed by respectively bending two ends of a corresponding first segment;
each bracket defines a mounting groove recessed inward from a surface of a first peripheral side surface thereof, each bracket further defines two mounting holes being strip-shaped and respectively penetrating through a second peripheral side thereof and a third peripheral side thereof, each second peripheral side is opposite to a corresponding third peripheral side, each two mounting holes are communicated with a corresponding inserting groove, and each two mounting holes are respectively defined at two opposite sides of a corresponding mounting groove and are communicated with the corresponding mounting groove;
each first segment is fixed in a corresponding mounting groove, each two second segments respectively pass through corresponding two mounting holes and extend into a corresponding inserting groove; and
each two second segments are elastically clamped in corresponding at least one limiting groove, so that a corresponding male connector is locked with a corresponding bracket.

3. The smart glasses according to claim 2, wherein a width of one end of each male connector away from the corresponding temple is less than or equal to a distance between corresponding two segments;
each at least one limiting groove comprises two limiting grooves, each two limiting grooves are respectively defined at two sides of a corresponding male connector corresponding to corresponding two second segments, wherein a distance between the two sides of the corresponding male connector is greater than the distance between the corresponding two second segments.

4. The smart glasses according to claim 3, wherein cross sections of each two segments are circular, and cross sections of each two limiting grooves are arc-shaped.

5. The smart glasses according to claim 2, wherein one end of each bracket close to the frame assembly is fixed in the corresponding clamping groove through adhesive bonding.

6. The smart glasses according to claim 4, wherein each female connector defines a buckling groove on one side thereof away from a corresponding first segment;
each bracket defines a through hole at a fourth peripheral side thereof close to a corresponding buckling groove and penetrating through the fourth peripheral side thereof;
each bracket further comprises a buckling portion at an area thereof corresponding to a corresponding through hole, each buckling portion is matched with a corresponding buckling groove; and
each buckling portion is buckled with the corresponding buckling groove to fix and clamp a corresponding bracket.

7. The smart glasses according to claim 1, wherein each temple defines a concave groove at the one end thereof close to a corresponding one of the two female connecting assemblies, each male connector is fixed in a corresponding concave groove through in-mold injection molding or adhesive bonding.

8. The smart glasses according to claim 1, wherein each female connector is a metal female connector, each bracket is a plastic bracket, and each male connector is a metal male connector.

9. The smart glasses according to claim 1, wherein each elastic metal component is a steel wire.

10. The smart glasses according to claim 1, wherein the two female connecting assemblies comprise two connecting components being arc-shaped and fixed to the frame assembly;
a hinge base is disposed on a peripheral side surface of each female connector, each hinge base is fixed to one end, away from the frame assembly, of a corresponding one of the two connecting components through a bolt.
